(19) United States
(12) Patent Application Publication
(10) Pub. No.: US 2005/0116503 A1
(43) Pub. Date: Jun. 2, 2005

(54) Safety cabin

(76) Inventors: Arndt Hartelt, Ulmen (DE); Oswald Gerd, Bonn (DE)

Correspondence Address: Horst M Kasper, 13 Forest Drive, Warren, NJ, 07059, US

(21) Appl. No.: 10/499,863

(22) PCT Filed: Dec. 13, 2002
(86) PCT No.: PCT/DE02/04613

(30) Foreign Application Priority Data
Dec. 21, 2001 (DE) 201 21 185.8

(51) Int. Cl. B62D 29/04

(52) U.S. Cl. 296/181.2; 296/203.01

(57) ABSTRACT

The Invention relates to a safety cell, in particular for motor vehicles in saloon car race sport. The safety cell is employed to receive the seat of the vehicle driver and thus to protect the vehicle driver against injuries based on an accident. The safety cell (monocoque) is here essentially subdivided into a seat region and a foot region and is produced out of carbon fibers having long fibers with a laminar structure in combination with aluminum and/or an aluminum honeycomb structure. The safety cell is flexible and employable in different vehicle types and meets the highest safety conditions.

The Invention relates to a safety cell, in particular for motor vehicles in the saloon car race sport according to the preamble of the first Patent claim. The safety cell is employed in motor vehicles, preferably in the saloon car race sport, for receiving the driver seat for thereby protecting the driver against injuries caused by an accident.

A safety seat is known from the German printed Patent document DE 29924054 U1,which safety seat is employed in the race sport for protecting the passengers. Here a safety seat is involved, wherein the safety seat is constructed according to the monocoque construction method and wherein the safety seat is particularly light weight formed by the employment of fiber reinforced material (CFK). The stiffiess of the safety seat is obtained by the formation of a honeycomb structure made of CFK, whereby the property of the CFK of providing high stiffness at low weight is only ideally used relative to the weight side. The high driver specific formation of the safety increasing element is to be considered a further disadvantage of this concept, since any safety seat has to be individually tuned to the driver, which tuning is associated with substantial costs. The formation of the side walls is dubious as to safety technology, since these side walls do not fully cover the driver on the side. Furthermore, the side walls exhibit a concave bulging directed in the direction toward the seat wall, wherein the bulging further runs in a relatively small transition radius in the direction toward the foot region such that in case of a hard crash a buckling can occur in this weakened side wall region.

It is an object of the Invention to furnish a safety cell, which exhibits a small individualising degree specific to the driver, which is flexible and employable in various vehicle types and which meets the highest safety conditions.

This object is achieved according to the present Invention with the characterizing features of the first Patent claim. The safety cell (monocoque) is here essentially subdivided into a seat region and a foot region and is produced out of carbon fibers having a long fiber with a laminar structure in combination with aluminum and/or an aluminum honeycomb structure. Here the stiffness of the safety cage can be varied by way of fiber orientation and/or the orientation of individual fibers or fiber layers relative to each other. The binding in of function carriers is performed by the separate bringing in of receiver blocks, wherein the receiver blocks can be bound into the monocoque through aluminum plates integrated into the monocoque structure, whereby also the average stiffness of the total structure can be increased. It is also possible that the function carriers to be bound into the receiver blocks are performed as an attachment for the steering column, the gear shift lever mechanism or the pedal plant. The monocoque can exhibit also openings and/or recesses, wherein the function carriers (receiver blocks) are bound to the monocoque by way of the openings and/or recesses. The safety cage is open in part, or, respectively, completely closed at the end of the foot space, wherein the safety cage exhibits openings and/or bore holes in the back, side, and floor region. The safety cell is fixed in its position at the vehicle frame structure by the openings/bore holes in the floor region and/or in the side region and/or through embedded function carriers, whereby the monocoque maintains its position in the vehicle also under the effect and interaction of large deformation forces. The modulus of shear of the floor group of the vehicle is simultaneously increased by the multipoint fixation. Preferably a total of 8 attachment points is integrated in the floor region of the seat cage, wherein in each case four rows with attachment points in each case two pairwise are disposed at a distance to each other.

The first side wall region of the monocoque disposed furthest most in the direction toward the vehicle outer side covers the sideways projected area of the vehicle driver in an upright seated position as well as in an inclined position in the direction of the length of the construction part up to the shoulder of the vehicle driver completely in height and width, in order to increase the safety in case of a side crash impact. The second side wall region of the monocoque covers the sideways projected area of the driver only in an upright seated position, up to the shoulder of the vehicle driver completely in height and width. The head protection region can be separately bound in at the safety cage, whereby a partial overlapping with the head protection region to be bound in results in the seat region. The head protection region can be attached on the inside and/or on the outside at the seat region. Preferably the head protection region is disposed at a seat receiver attachable in the seat region.

The steering can be connected to the monocoque depending on the load, wherein also a height level adjustment of the steering wheel is possible based on the dimensioning or, respectively, the positioning of the receiver blocks in or, respectively, on the monocoque.

It is furthermore advantageous in case of a fire, if at least the outer contour of the safety cage is furnished with a fire proof or flame resistant coating or foil or heat resistant coating.

One or several airbags can be integrated in the region of the side walls and/or the foot region, wherein the binding in of the airbags is performed through functional elements.

An increased number of carbon fiber layers and/or layers out of aluminum or aluminum honeycomb structure are furnished to the side wall region disposed furthest most in the direction toward the outside of the vehicle and/or in the foot region as compared to other regions of the seat cage in order to furnish the largest possible protection to the particularly endangered regions.

The Invention is in the following illustrated in more detail by way of embodiment examples and associated drawings.

There is shown in:

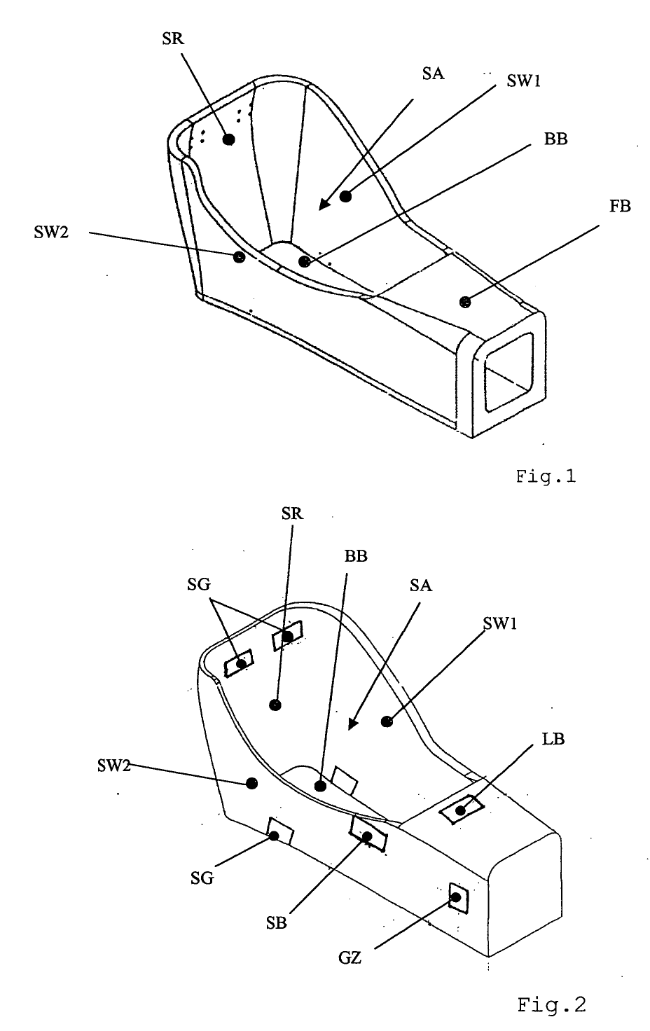

FIG. 1: safety cell in a three-dimensional view,

FIG. 2: safety cell in a three-dimensional view with openings/recesses for binding in of function carriers,

FIG. 3: safety cell in a side elevational view,

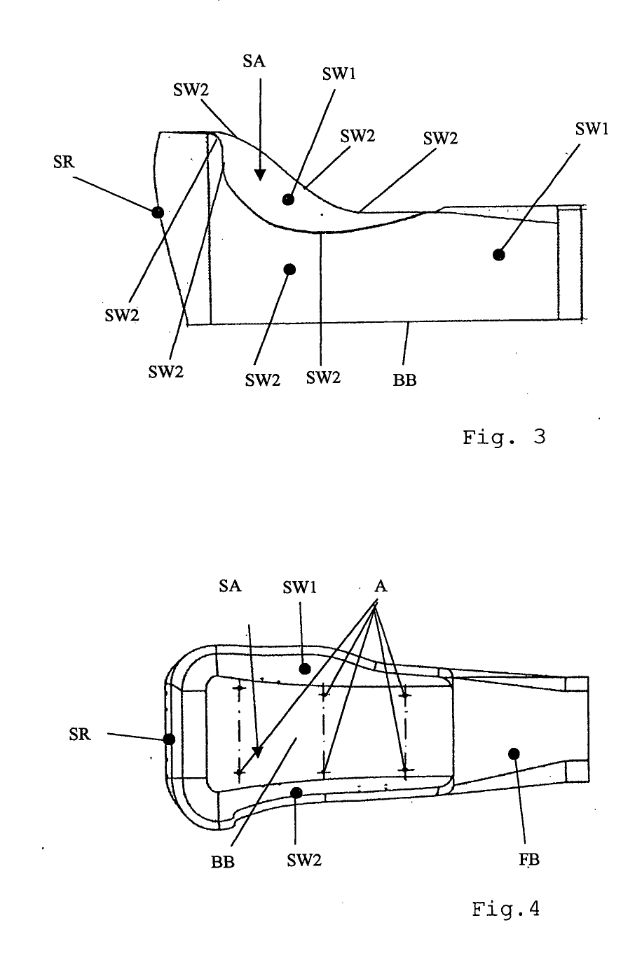

FIG. 4 safety cell in a top planar view.

FIG. 1 shows the safety cell with two main components: seating region SA and foot region FB. The seat receiver SA exhibits a back rest region SR and a first side wall region SW1 as well as a second side wall region SW2, wherein the side wall regions SW1, SW2 extend up to the foot region FB.

FIG. 2 shows the safety cell with rectangles indicating the corresponding positions and function elements FB embedded in the monocoque structure FB for the receiving of the steering rod, GZ for the receiving of the accelerator assembly, SB for the receiving for the gear shift lever mechanism as well as SG the mounting position for the safety belt.

The safety cell is illustrated in a side elevational view in FIG. 3 width a second side wall SW2 in the foreground disposed about in the middle of the vehicle. The upper edge of the second side wall SW2 runs here from the seat region SA to the foot region FB first in a convex curved radius R3, wherein a linear vertical in the direction toward the floor indicating region L2 following to the convex curved radius R3, wherein an essentially convex curved region R4 borders the floor indicating region L2. The upper edge of the first side wall SW1 runs from the seat region SA to the foot region FB first in a concave curved radius R1, then in a downwardly inclined region L following to the concave curved radius R1, approximately linear at an acute angle alpha in the direction toward the foot region FB and in a then following concave curved radius R2. A buckling of the monocoque is excluded based on the in driving direction inclined orientation of the side wall course with the only slightly swiveled transitions.

FIG. 4 shows the safety cell in a top planar view with the binding in points A for fixation at the frame structure not illustrated. The simple exchangeability of the safety cell is assured by the fixed attachment points A.

The mode of operation of the safety cell is the following:

In order to protect the driver of a saloon car against injuries through an accident, the survival space of the driver has to be secured by a particular stiff structure, by a structure standing up to also a hard crash. These high safety conditions are taken care of by the employment of a safety cell made out of carbon fibers having long fibers of defined orientation with an aluminum honeycomb structure embedded and interlaced between the carbon fiber layers. The safety cell here exhibits essentially a seat region SA and a foot region FB (FIG. 1).

The stiffness of the safety cell, such as for example in the foot region FB (FIG. 1), can be purposefully increased in particular by the employment of carbon fibers with long fibers in connection with aluminum honey comb in order to prevent therewith a possible deformation of the survival space as for example in the case of a front collision crash. This increase of the stiffness and/or elasticity can be performed by a corresponding adaptable number and/or orientation of the layers of fibers/fiber layers, wherein the zones with increased stiffness or, respectively, zones with desired elasticity can be influenced by the orientation individual fibers and/or fiber layers or, respectively, aluminum honeycomb layers relative to each other. Further function parts such as steering wheel/steering column and gear shift lever mechanism are integrated into the safety cell in order to protect the vehicle driver against injuries by the further function parts such as steering wheel/steering column and gear shift lever mechanism. This integration can be performed through receiver blocks, wherein the receiver blocks themselves exhibit a high stiffness, thereby the parts such as steering block LB, switching block SG, accelerator installation GZ, belt system GZ (FIG. 2) as well as the binding in points A (FIG. 4) of the monocoque at the vehicle frame structure maintain their position also under the influence of large forces. However it is also possible to support the receiver blocks depending on load on aluminum plates previously entered into the structure. The safety cell exhibits a long extended side wall SW (FIG. 3) in the direction toward the middle of the vehicle for the case of a side crash impact in order to thereby prevent a buckling out in the direction of the middle of the vehicle, whereby the risk of injury is also reduced.

The safety of the safety seat can be further increased by a coating of the complete safety cell or at least of the outer contour of the safety cell with a fire proof or flame resistant coating or foil or with a heat resistant coating and by the installation of airbags.

The reinforcement of particularly endangered regions by an increased number of carbon fiber layers and/or layers out of aluminum or out of an aluminum honeycomb structure is not illustrated in more detail.

Overall a safety cell is created for a saloon car race sport, wherein the safety cell withstands even the highest loads and thus offers a maximum of safety for the vehicle driver.

1. Safety cell, in particular for motor vehicles in saloon car race sport, made out of fiber composite material (CFK) in monocoque construction fashion, wherein the monocoque comprises a seat region (SA) and a foot region (FB) and out of carbon fibers having long fibers with a laminate structure in combination with aluminum and/or an aluminum honeycomb structure.

2. Safety cell according to claim 1 characterized in that the stiffness of the safety cell is variable by way of fiber orientation and/or the orientation of individual fibers or fiber layers.

3. Safety cell according to claim 1 characterized in that the binding in of function carriers and/or binding in points (A) is performed by receiver blocks separately to be entered.

4. Safety cell according claim 1, characterized in that the binding in of the receiver blocks can be performed through aluminum plates integrated into the monocoque structure.

5. Safety cell according to claim 1, characterized in that the average stiffness of the overall structure is increased by the binding in and by the dimensioning of function carriers and/or binding in points (7).

6. Safety cell according to claim 5 characterized in that at least one function carrier (LB) integrated into the upper side of the foot region (FB) is formed as a binding in for the steering column.

7. Safety cell according to claim 6, characterized in that the function carrier (SB) is formed in one of the side walls (SW1, SW2) as an attachment for the gear shift lever mechanism.

8. Safety cell according to claim 7, characterized in that a fundtion carrier integrated into the lower side of the foot region (FB) is formed as an attachment for the accelerator assembly.

9. Safety cell according to claim 1, characterized in that the monocoque exhibits openings for binding in of function carriers.

10. Safety cell according to claim 1, characterized in that the monocoque exhibits recesses for binding in of function carriers.

11. Safety cell according to claim 1, characterized in that the monocoque is partially or completely closed at the end of the foot space (FB).

12. Safety cell according to claim 1, characterized in that the monocoque exhibits openings and/or bore holes in the rear region, the side region, and the floor region (BB).

13. Safety cell according to claim 1, characterized in that the binding in of the monocoque to the vehicle frame structure is performed through the openings and/or bore holes in the floor region (BB) and/or the openings/bore holes in the side region and/or through binding in points (A) in the floor region (BB).

14. Safety cell according to claim 1, characterized in that the side wall (SWI) of the monocoque disposed toward the floor of the vehicle driver covers the sideways projected area of the driver in an upright seated position as well as with inclined position in the direction of the longitudinal direction of the construction part up to the shoulder of the vehicle driver completely in height and width.

15. Safety cell according to claim 1 characterized in that the side wall (SW2) of the monocoque disposed remote from the door of the vehicle driver completely covers the sideways projected area of the driver in an upright seated position up to the shoulder of the driver completely in height and width.

16. Safety cell according to claim 1. characterized in that the end of the seat region (SA) pointing in the direction toward the head region overlaps to form a head projection region.

17. Safety cell according to claim 1, characterized in that the head protection region is attachable on the inside and/or on the outside at the seat region (SA).

18. Safety cell according to claim 1, characterized in that the head protection region is disposed at the seat receiver attachable in the seat region (SA).

19. Safety cell according to claim 1, characterized in that a person retaining system is integrated into the monocoque.

20. Safety cell according to claim 1 characterized in that the steering column is adjustable in height level with the dimensioning of the receiver block.

21. Safety cell according to claim 1, characterized in that the monocoque maintains its position in the vehicle under the impact of large deformation forces.

22. Safety cell according to claim 1, characterized in that the steering column is supported depending on load.

23. Safety cell according to claim 1, characterized in that the upper edge of the first side wall (SW1) runs from the seat region (SA) to the foot region (FB) first in a convex curve radius (R1), in a then following nearly linear region (L) at an acute angle (alpha) in the direction toward the foot region (FB) to a downward inclined region (L) and to a following concave curved radius (R2).

24. Safety cell according to claim 1, characterized in that the upper edge of the second side wall (SW2) runs from the seat region (SA) to the foot region (FB) first in a convex curve radius (R3), then runs along a linear region (L2) pointing vertical in the direction toward the floor region (BB), wherein an essentially convex curved region (R4) follows to the linear region (L2).

25. Safety cell according to claim 1, characterized in that a total of eight binding in points (A) for the attachment at the floor group is integrated in the floor region (BB) of the seat cell, wherein in each case 4 rows with in each case two binding in points (A) disposed pairwise at a distance relative to each other are furnished.

26. Safety cell according to claim 25 characterized in that the modulus of shear of the floor group is increased by the attachment of the safety cell.

27. Safety cell according to claim 1 characterized in that at least the outer contour of the safety cell is furnished with a fire proof or flame resistant coating or foil.

28. Safety cell according to claim 1 characterized in that at least the outer contour of the safety cell is furnished with a heat resistant coating or foil.

29. Safety cell according to claim 1, characterized in that one or several airbags are integrated in the region of the side walls (SW1, SW2) and/or of the foot region (FB), wherein the binding in of the airbags is performed through function elements.

30. Safety cell according to claim 1 characterized in that the side wall region disposed furthest in the direction toward the outside of the vehicle and/or the foot region exhibits an increased number of carbon fiber layers and/or layers of aluminum or of aluminum honeycomb structure in comparison to the other regions of the seat cell.
